(19) United States
(12) Patent Application Publication
(10) Pub. No.: US 2023/0187198 A1
(43) Pub. Date: Jun. 15, 2023

(54) METHOD OF OPERATING A CHARGE DETECTION MASS SPECTROMETER AND A CHARGE DETECTION MASS SPECTROMETER

(71) Applicant: Waters Technologies Corporation, Milford, MA (US)

(72) Inventors: Joseph A. Jarrell, Newton Highlands, MA (US); Patrick Brophy, Newton Highlands, MA (US); Kevin Giles, Stockport (GB)

(73) Assignee: Waters Technologies Corporation, Milford, MA (US)

(21) Appl. No.: 18/066,099

(22) Filed: Dec. 14, 2022

Related U.S. Application Data
(60) Provisional application No. 63/289,964, filed on Dec. 15, 2021.

(51) Int. Cl. H01J 49/42; H01J 49/00

(52) U.S. Cl. CPC H01J 49/429; H01J 49/4245; H01J 49/0036

(57) ABSTRACT

There is provided a method of operating a charge detection mass spectrometer (CDMS), the CDMS comprising an electrostatic ion trap, the electrostatic ion trap comprising a plurality of electrodes, the method comprising: a) introducing a first ion into the electrostatic ion trap at a first ion energy, b) setting the voltage of the plurality of electrodes to a first voltage map, c) obtaining first CDMS data indicative of a first ion oscillation frequency, d) obtaining an acceptable range or ranges of ion oscillation frequencies, e) changing the first ion energy to a second ion energy and/or changing the first voltage map to a second voltage map, and f) obtaining second CDMS data indicative of a second ion oscillation frequency.

### CROSS-REFERENCE TO RELATED APPLICATIONS

This application claims priority to and benefit of U.S. Provisional Patent Application No. 63/289,964, filed Dec. 15, 2021. The entire disclosure of which is hereby incorporated by reference.

### TECHNICAL FIELD

This specification relates to methods of operating a charge detection mass spectrometer and a charge detection mass spectrometer. More particularly, although not exclusively, this specification relates to methods of operating a charge detection mass spectrometer a charge detection mass spectrometer, a computer readable medium, and a computer program.

It is a non-exclusive aim of this disclosure to provide improved methods of operating charge detection mass spectrometers and to provide an improved charge detection mass spectrometer.

### BACKGROUND

It is known to operate charge detection mass spectrometers to determine ion mass-to-charge ratios, ion charges, and ion masses. However, background noise and/or low measured signal intensity may provide challenges in accurately measuring and determining ion mass-to-charge ratios, ion charges, and ion masses.

### SUMMARY

There is provided a method of operating a charge detection mass spectrometer (CDMS),
the CDMS comprising an electrostatic ion trap, the electrostatic ion trap comprising a plurality of electrodes, the method comprising:
   a) introducing a first ion into the electrostatic ion trap at a first ion energy,
   b) setting the voltage of the plurality of electrodes to a first voltage map,
   c) obtaining first CDMS data indicative of a first ion oscillation frequency,
   d) obtaining an acceptable range or ranges of ion oscillation frequencies,
   e) changing the first ion energy to a second ion energy and/or changing the first voltage map to a second voltage map, and
   f) obtaining second CDMS data indicative of a second ion oscillation frequency.

The method of operating a charge detection mass spectrometer (CDMS) method may include performing the following steps in the following order:
d) obtaining an acceptable range or ranges of ion oscillation frequencies,
e) changing the first ion energy to a second ion energy and/or changing the first voltage map to a second voltage map, and
f) obtaining second CDMS data indicative of a second ion oscillation frequency.

Obtaining an acceptable range or ranges of ion oscillation frequencies may include obtaining a range or ranges known to include relatively low-intensity background noise under the conditions used to obtain the first CDMS data.

The second ion oscillation frequency may be a frequency within the acceptable range or ranges of ion oscillation frequencies.

The method may include performing the following steps in the following order:
e) changing the first ion energy to a second ion energy and/or changing the first voltage map to a second voltage map,
f) obtaining second CDMS data indicative of a second ion oscillation frequency, and
d) obtaining an acceptable range or ranges of ion oscillation frequencies.

The obtaining an acceptable range or ranges of ion oscillation frequencies may include determining a range or ranges of relatively high-intensity background noise that lie(s) in a same range or ranges in the first CDMS data and the second CDMS data.

The acceptable range or ranges of frequencies may be a resonant frequency range or ranges of an amplification device connected to a detection tube of the electrostatic ion trap.

The amplification device may have a plurality of selectable resonant amplification frequency range or ranges.

The amplification device may comprise:
an amplifier with a plurality of resonant amplification frequency range or ranges, and/or
an array of a plurality of selectable amplifiers, each selectable amplifier having a resonant amplification frequency range or ranges.

The changing the first ion energy to a second ion energy may be achieved by introducing a second ion into the electrostatic ion trap at the second ion energy.

The method may include ramping the first voltage map to the second voltage map over a period of from 0.2 milliseconds to 10 milliseconds.

The first ion oscillation frequency may be determined by performing a fast Fourier transform on the first CDMS data and/or the second ion oscillation frequency may be determined by performing a fast Fourier transform on the second CDMS data.

The method may further include:
changing the second ion energy to a third ion energy and/or changing the second voltage map to a third voltage map, and
obtaining third CDMS data indicative of a third ion oscillation frequency.

The third ion oscillation frequency may be determined by performing a fast Fourier transform on the third CDMS data.

The method may include ramping the second voltage map to the third voltage map over a period of from 0.2 milliseconds to 10 milliseconds.

There is also provided a method of operating a charge detection mass spectrometer (CDMS), the CDMS comprising:
an electrostatic ion trap comprising a plurality of electrodes,
a detection tube, and
an amplification device connected to the detection tube having a plurality of
selectable resonant amplification frequency range or ranges,
   wherein the method comprises:
a) introducing a first ion into the electrostatic ion trap at a first ion energy,
b) setting the voltage of the plurality of electrodes to a first voltage map,
c) obtaining first CDMS data indicative of a first ion oscillation frequency,
d) selecting the resonant amplification frequency range or ranges to correspond with the first ion oscillation frequency, and
e) obtaining second CDMS data indicative of the first ion oscillation frequency.

The amplification device may comprise:
an amplifier with a plurality of selectable resonant amplification frequency range or ranges, and/or
an array of a plurality of selectable amplifiers.

At least one of the plurality of selectable amplifiers may be a resonant amplifier having a resonant amplification frequency range or ranges.

At least one of the plurality of selectable amplifiers may be a non-resonant amplifier.

The method may include performing the following steps in the following order:
c) obtaining first CDMS data indicative of a first ion oscillation frequency,
d) selecting the resonant amplification frequency range or ranges to correspond with the first ion oscillation frequency, and
e) obtaining second CDMS data indicative of the first ion oscillation frequency.

The method may further include:
g) changing the first ion energy to a second ion energy and/or changing the first voltage map to a second voltage map,
h) obtaining third CDMS data indicative of a second ion oscillation frequency,
i) selecting the resonant amplification frequency range or ranges to correspond with the second first ion oscillation frequency,
j) obtaining fourth CDMS data indicative of the second ion oscillation frequency.

There is also provided a charge detection mass spectrometer (CDMS) for carrying out the method(s) as described herein, comprising:
an electrostatic ion trap comprising at least two electrodes configurable to be set to a voltage map;
a detection tube; and
an amplification device connected to the detection tube,
the amplification device having a plurality of selectable resonant amplification frequencies.

The amplification device may comprise:
an amplifier with a plurality of selectable resonant amplification frequency ranges, and/or
an array of a plurality of selectable amplifiers.

At least one of the plurality of selectable amplifiers may be a resonant amplifier having a resonant amplification frequency range or ranges.

At least one of the plurality of selectable amplifiers may be a non-resonant amplifier.

The CDMS may include a plurality of detection tubes.

The amplification device may comprise an array of a plurality of selectable amplifiers, the plurality of selectable amplifiers being connected to each of the plurality of detection tubes.

At least one of the plurality of selectable amplifiers may be a resonant amplifier having a resonant amplification frequency range or ranges.

At least one of the plurality of selectable amplifiers may be a non-resonant amplifier.

The CDMS may further include at least one refocusing optic between each of the plurality of detection tubes.

There is also provided a computer readable medium having instructions stored thereon which, when executed by a processor, cause the performance of a method of operating a charge detection mass spectrometer (CDMS) as described herein.

There is also provided a computer program comprising instructions which, when executed by a processor, cause the performance of a method of operating a charge detection mass spectrometer (CDMS) as described herein.

There is also provided a system comprising at least one processor and a computer readable medium, wherein the computer readable medium has instructions stored thereon which, when executed by the at least one processor, cause the system to perform a method of operating a charge detection mass spectrometer (CDMS) as described herein.

There is also provided a charge detection mass spectrometer (CDMS) comprising at least one processor and a computer readable medium, wherein the computer readable medium has instructions stored thereon which, when executed by the at least one processor, cause the system to perform a method of operating a charge detection mass spectrometer (CDMS) as described herein.

### BRIEF DESCRIPTION OF THE DRAWINGS

In order that the present disclosure may be more readily understood, preferable embodiments thereof will now be described, by way of example only, with reference to the accompanying drawings, in which:

FIG. 1 shows two frequency domain graphs obtained by an embodiment method according to the present disclosure; FIG. 1a shows a signal representative of an ion overlapping a region of relatively high-intensity background noise and FIG. 1b shows a signal representative of an ion located at a frequency away from a region of relatively high-intensity background noise;

FIG. 2 shows stable ion oscillation frequencies in respect of varying voltage configurations of electrodes according to an embodiment;

FIG. 3 shows a side-view schematic of an electrostatic ion trap of a charge detection mass spectrometer of an embodiment of the present disclosure, and the effect of voltage configurations of the electrodes on ion oscillation frequency and distance of the ion traveled past the electrodes;

FIG. 4 shows representative graphs of ion signal against time according to an embodiment;

FIG. 5 shows representative graphs of ion signal against frequency according to the embodiment of FIG. 4;

FIG. 6 shows a representative graph of signal noise against frequency of a representative resonant amplifier and non-resonant amplifier according to an embodiment;

FIG. 7 shows a block-diagram of a method of operating a charge detection mass spectrometer according to an embodiment;

FIG. 8 shows a block-diagram of a method of operating a charge detection mass spectrometer according to an embodiment;

FIG. 9 shows a block-diagram of a method of operating a charge detection mass spectrometer according to an embodiment;

FIG. 10 shows a block-diagram of a method of operating a charge detection mass spectrometer according to an embodiment;

FIG. 11 shows a block-diagram of a method of operating a charge detection mass spectrometer according to an embodiment;

FIG. 12 shows a block-diagram of a method of operating a charge detection mass spectrometer according to an embodiment;

FIG. 13 shows a block-diagram of a method of operating a charge detection mass spectrometer according to an embodiment;

FIG. 14 shows a graph of relationships between ion energy, ion oscillation frequency, and ion mass/charge obtained from a method of operating a charge detection mass spectrometer according to an embodiment;

FIG. 15 shows a side-view schematic of an electrostatic ion trap of a charge detection mass spectrometer of an embodiment of the present disclosure; and

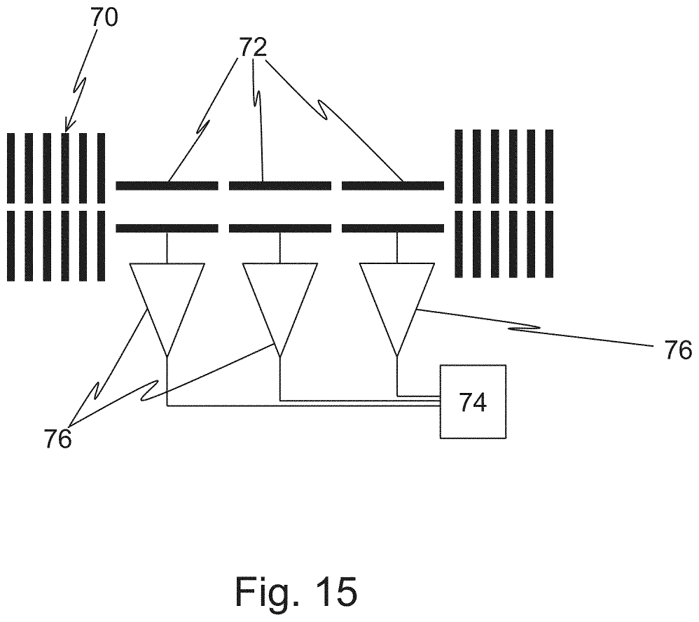

FIG. 16 shows representative graphs of ion signal intensity against time (FIG. 16a) and ion signal intensity against frequency (FIG. 16b) for a centrally located (solid line) detection tube and an off-centre (dashed line) detection tube of an electrostatic ion trap of a charge detection mass spectrometer of an embodiment of the present disclosure.

### DETAILED DESCRIPTION

Charge Detection Mass Spectrometry (CDMS) is achieved using electrostatic ion traps, such as cone traps or electrostatic linear ion traps (ELITs). One or more ions may be trapped during a single trapping event (e.g. when an ion(s) is introduced into the electrostatic ion trap). The number of ions in the trap must be kept sufficiently low such that there is a low probability of trapping multiple ions with the same mass-to-charge ratio (m/z) to ensure unambiguous ion counting and charge assignment. The result of this constraint is that the signal intensity (e.g. a signal representative of an ion) at a given m/z is low. When the results of the CDMS trapping event are plotted as signal intensity (e.g. a signal representative of an ion) against time (time domain CDMS data), the resulting oscillating waveform representative of an ion may be indistinguishable from background noise. Further, when plotted in respect of signal intensity against frequency (frequency domain CDMS data), the amplitude of a frequency peak representative of an ion may be the same amplitude as persistent noise peaks present in the frequency spectrum.

CDMS depends upon accurately quantifying the frequency domain signal amplitude of single ions that are present in a single trapping event. As discussed above, the signal intensity (e.g. a signal representative of an ion) can be small, and this may be especially true for ions with low charge numbers. If an ion's m/z falls within a frequency region where a background frequency peak exists, the amplitude of the frequency domain peak may be artificially increased and the charge may be misassigned, leading to mass assignment errors.

Background noise peaks may arise from numerous sources such as roughing pumps, turbomolecular pumps, noise present in the design of the amplifier, mechanical vibration, and ambient sources. It is known to carry out simple background subtraction to reduce background noise: a background spectrum is acquired by blocking the ion beam (or turning off the source of ions) and then initiating a trapping event. This approach may reduce the persistent, unwanted noise peaks, but there is no guarantee that these noise peaks are stable (i.e., the background noise may fluctuate in respect of signal amplitude or frequency). This results in the amplitude of the ion's frequency domain peak becoming artificially increased (or decreased) and the charge misassigned, which may lead to mass assignment errors.

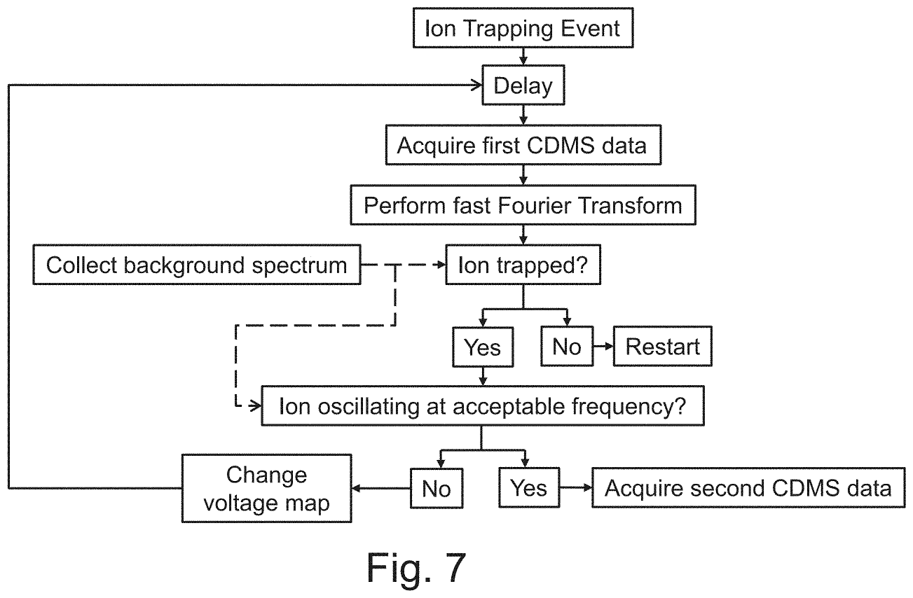

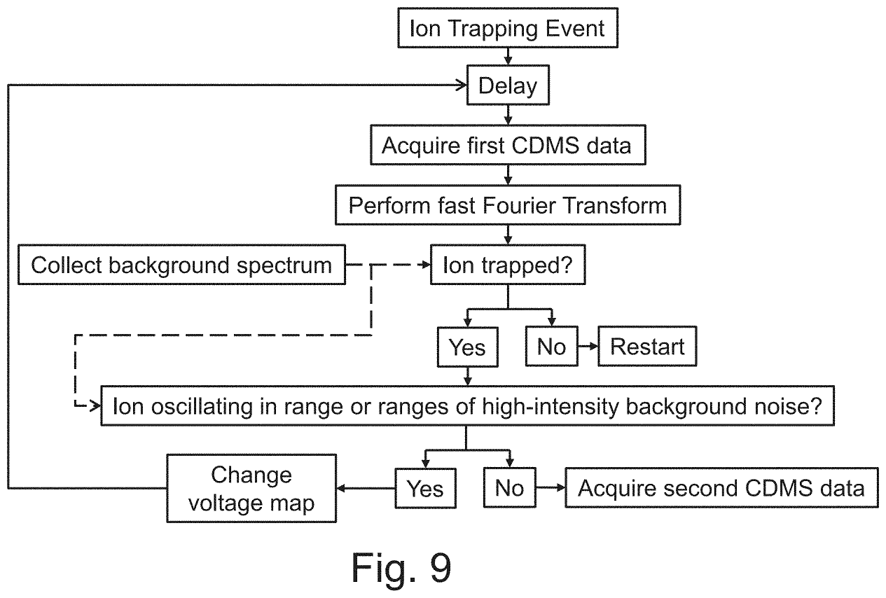

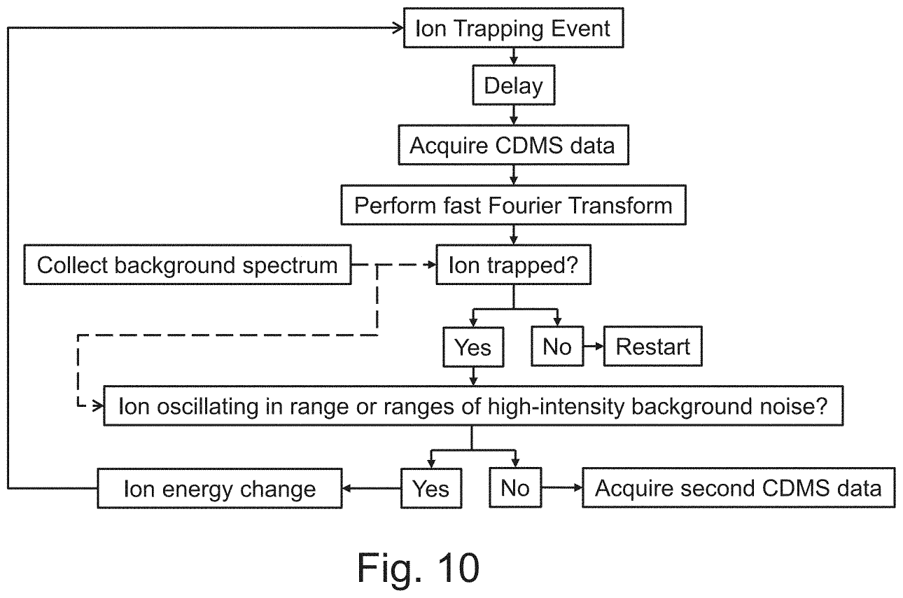

There is provided a method of operating a charge detection mass spectrometer (CDMS). The CDMS comprises an electrostatic ion trap and the electrostatic ion trap comprises at least two electrodes. With reference to FIGS. 7 to 12, the method comprises: a) introducing a first ion into the electrostatic ion trap at a first ion energy, b) setting the voltage of the plurality of electrodes to a first voltage map, c) obtaining first CDMS data indicative of a first ion oscillation frequency, d) obtaining an acceptable range or ranges of ion oscillation frequencies, e) changing the first ion energy to a second ion energy and/or changing the first voltage map to a second voltage map, and f) obtaining second CDMS data indicative of a second ion oscillation frequency. With reference to FIGS. 9 and 10, the step of d) obtaining an acceptable range or ranges of ion oscillation frequencies may comprise determining whether an ion is oscillating in a range or ranges of high-intensity background noise (e.g. the acceptable range or ranges of ion oscillation frequencies may be outside of the range or ranges of high-intensity background noise). CDMS data (e.g. the first CDMS data, and/or the second CDMS data, or and/other CDMS data such as third or fourth CDMS data described below) may include data representative of ion mass-to-charge ratio (m/z), and/or ion charge (z), and/or ion mass (m) (e.g. CDMS data may be indicative of an ion).

The first ion may be introduced into the electrostatic ion trap using a method as is known per se, e.g. by switching off the electrode(s) at one end of an electrostatic ion trap when introducing the first ion into the electrical ion trap.

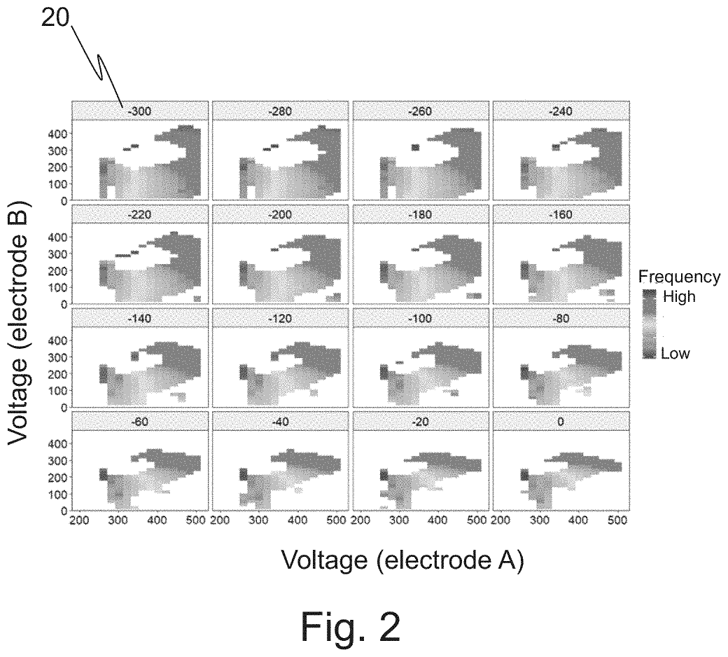

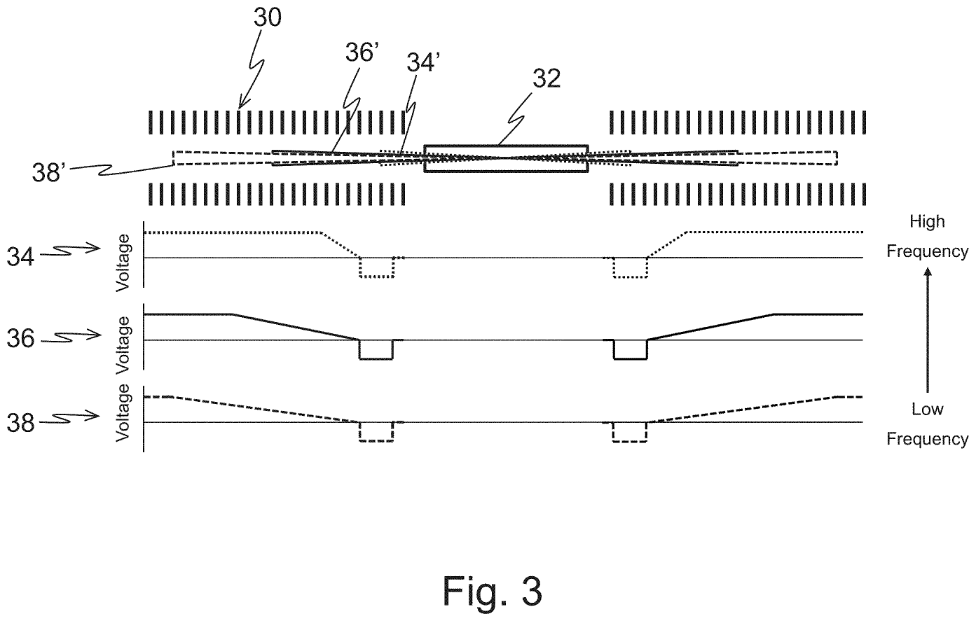

Methods of operating a charge detection mass spectrometer (CDMS) as described above may provide advantages. In particular, a trap with a given geometry —e.g. number of lenses, length of a pickup tube, lens spacing, etc. may determine the voltages that can be assigned to each electrode to produce a voltage map which produces stable trajectories for ions with a given energy and phase space. Numerous stable voltage maps may exist for a given trap geometry, as shown in FIGS. 2 and 3. This may also be true of cone traps which contain only a single tunable electrode at each side of the trap. Stable voltage configuration solutions have been found to produce a range of ion oscillation frequencies (as shown in FIGS. 2 and 3). The different frequencies may arise from different axial-potential gradients being established in the trap resulting in ions traveling different lengths along the axis of the trap and spending more (or less) time in a reflectron region of the trap (e.g. the amount of time the ion will spend in the region of the trap where the electrode(s) are located). An ion with a given energy may spend the same amount of time traveling through the field-free region of the detection tube 32, but the voltage-dependent penetration depth and time spent in the reflectron may result in a different number of cycles occurring per unit time (i.e. resulting in a different ion oscillation frequency). This is further shown in FIGS. 3, 4 and 5, which are discussed in detail, below. The steps of (a) to (f) as described above may be performed in any order.

The method of operating a charge detection mass spectrometer (CDMS) method may include performing the following steps in the following order: d) obtaining an acceptable range or ranges of ion oscillation frequencies, e) changing the first ion energy to a second ion energy and/or changing the first voltage map to a second voltage map, and f) obtaining second CDMS data indicative of a second ion oscillation frequency.

Obtaining an acceptable range or ranges of ion oscillation frequencies may include obtaining a range or ranges known to include relatively low-intensity background noise under the conditions used to obtain the first CDMS data. The range or ranges known to include relatively low-intensity background noise under the conditions used to obtain the first CDMS data may be obtained by obtaining a range or ranges known to include relatively high-intensity background noise under the conditions used to obtain the first CDMS data (as shown in FIGS. 9 and 10). Accordingly, obtaining an acceptable range or ranges of ion oscillation frequencies may include obtaining a range or ranges known to include relatively high-intensity background noise under the conditions used to obtain the first CDMS data. When obtaining an acceptable range or ranges of ion oscillation frequencies in this way, changing the first ion energy to the second ion energy and/or changing the first voltage map to the second voltage map may result in the second ion oscillation frequency being within the range or ranges known to include relatively low-intensity background noise under the conditions used to obtain the first CDMS data. In other words, changing the first ion energy to the second ion energy and/or changing the first voltage map to the second voltage map may result in the second ion oscillation frequency being outside of the range or ranges known to include relatively high-intensity background noise under the conditions used to obtain the first CDMS data. Accordingly, when the second ion oscillation frequency is outside of the range or ranges known to include relatively high-intensity background noise under the conditions used to obtain the first CDMS data, increased quality may be obtained and/or confidence of subsequent CDMS data obtained may be increased (e.g. the subsequent CDMS data obtained may be known to be unaffected by background noise e.g. the relatively high-intensity background noise).

The second ion oscillation frequency may be a frequency within the acceptable range or ranges of ion oscillation frequencies. This may allow for the second CDMS data indicative of a second ion oscillation frequency to be unaffected by background noise.

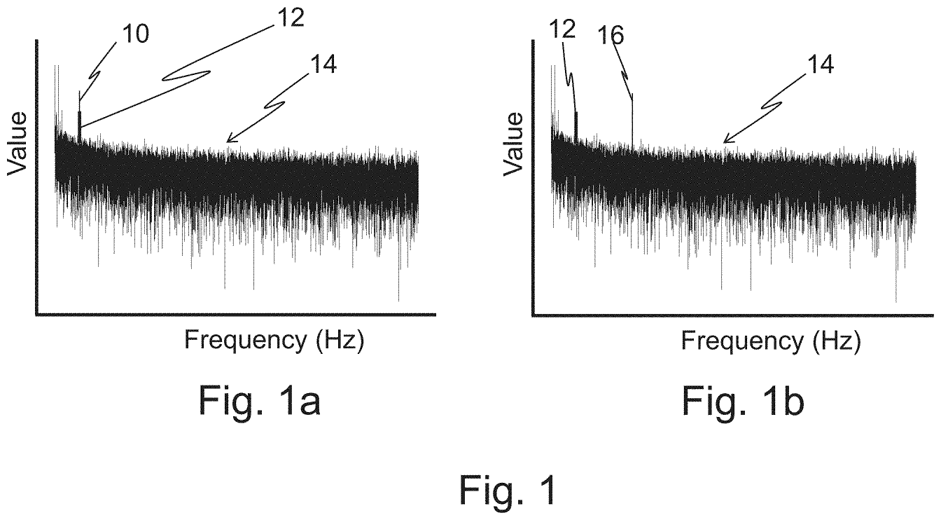

With reference to FIGS. 1 to 5 and 7 to 11, methods of operating a charge detection mass spectrometer (CDMS) as described above may provide advantages. In particular, in the event the first ion oscillation frequency is outside of the acceptable range or ranges of ion oscillation frequencies, changing the first ion energy to a second ion energy and/or changing the first voltage map to a second voltage map may adjust the first ion oscillation frequency to the second ion oscillation frequency, and the second ion oscillation frequency may be within the acceptable range or ranges of ion oscillation frequencies. With reference to FIG. 1, there may be the first ion oscillation frequency 10 signal, a region(s) of relatively high-intensity background noise 12, and a region(s) of low(er) background noise 14. Region(s) of relatively high-intensity background noise may also be described as a range or ranges of relatively high-intensity background noise, and/or region(s) of low(er) background noise may also be described as a range or ranges of relatively low-intensity background noise as described herein. It is to be understood that a region(s) of low(er) background noise 14 may still contain a region(s) of background noise; the region(s) of low(er) background noise may have a background noise intensity lower than a region(s) of high-intensity background noise 12. As shown in FIG. 1a, the first ion oscillation frequency 10 signal may be located in the same region(s) as a region(s) of relatively high-intensity background noise 12. In the case of FIG. 1, the acceptable range or ranges of ion oscillation frequencies may be any frequency not located in a region(s) of relatively high-intensity background noise 12, i.e. a frequency located within a region of low(er) background noise 14. FIG. 2 shows a representative graph of the effect of electrode voltage configurations (as shown on the x and y axes, and values 20), i.e. voltage maps, on ion oscillation frequency and stability. With reference to FIG. 2, a second voltage map of the at least two electrodes may selected such that an ion of known energy (i.e. the first ion energy) may oscillate at a desired stable frequency, e.g. away from a region(s) of relatively high-intensity background noise 12. After changing the voltage map from the first voltage map to the second voltage map, the first ion oscillation frequency 10 may be changed to the second ion oscillation frequency 16, such that the first ion oscillates at the second ion oscillation frequency 16. As shown in FIG. 1b, the second ion oscillation frequency 16 may be located away from a region(s) of relatively high-intensity background noise 12. Further, optionally, as shown in FIGS. 7 to 10, first CDMS data may be collected, a fast Fourier transform may be performed as is known per se, and analysis may be carried out to determine whether an ion has been trapped in the electrostatic ion trap. Accordingly, if it is determined that no ion has been trapped, the method may be restarted; alternatively, if it is determined that an ion has been trapped, the method may continue.

For reasons of brevity, unless otherwise specified, when used in this specification, the general use of “ion” may refer to the first ion, a second ion, or another ion introduced into the electrostatic ion trap, the general use of “ion oscillation frequency” may refer to the first ion oscillation frequency, the second ion oscillation frequency, or another ion oscillation frequency, the general use of “voltage map” may refer to the first voltage map, the second voltage map, or another voltage map, and the general use of ion energy may be the first ion energy, the second ion energy, or another ion energy; changing a voltage map (e.g. changing the first voltage map to the second voltage map, and/or changing the second voltage map to a third voltage map, as described below) may refer to setting the voltage of the plurality of electrodes 30, 70 to a different voltage map (e.g. the second voltage map and/or the third voltage map). Further, “ion energy” is to be understood as referencing ion kinetic energy per unit charge (eV/z), i.e. electron volts (eV) per charge number (z).

FIG. 3 shows a schematic side view of an electrostatic ion trap comprising multiple electrodes 30 and a detection tube 32, and shows voltage maps 34, 36, 38 of the electrodes 30. As shown in FIG. 3, setting the voltage of the at least two electrodes 30 to different voltage maps as shown in graphs 34, 36, and 38, may affect ion oscillation frequency. As shown in FIG. 3, a high frequency voltage map 34 may result in a high ion oscillation frequency pattern 34′, resulting from low penetration into the electrode regions of the electrostatic ion trap. As is also shown in FIG. 3, a low frequency voltage map 38 may result in a low ion oscillation frequency pattern 38′, resulting from deep penetration into the electrode regions of the electrostatic ion trap. A frequency voltage map 36 between the high frequency voltage map and the low frequency voltage map (i.e. an ‘intermediate’ voltage map) may result in an ‘intermediate’ ion oscillation frequency pattern 36′, resulting from a degree penetration into the electrode regions of the electrostatic ion trap of between the high frequency voltage map 34 and the low frequency voltage map 38. Additionally or alternatively, the penetration of the ion into the electrode regions of the electrostatic ion trap may be altered by changing the ion energy (e.g. by changing the first ion energy to a second ion energy). In particular, the first ion energy may be changed to the second ion energy by introducing a second ion into the electrostatic ion trap, as described in more detail, below.

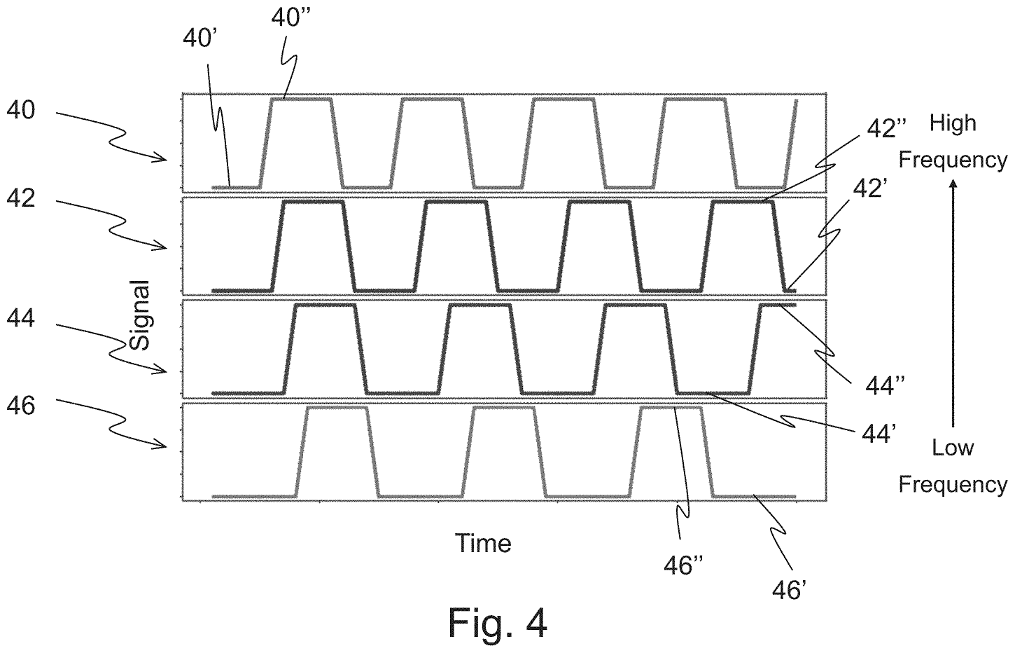

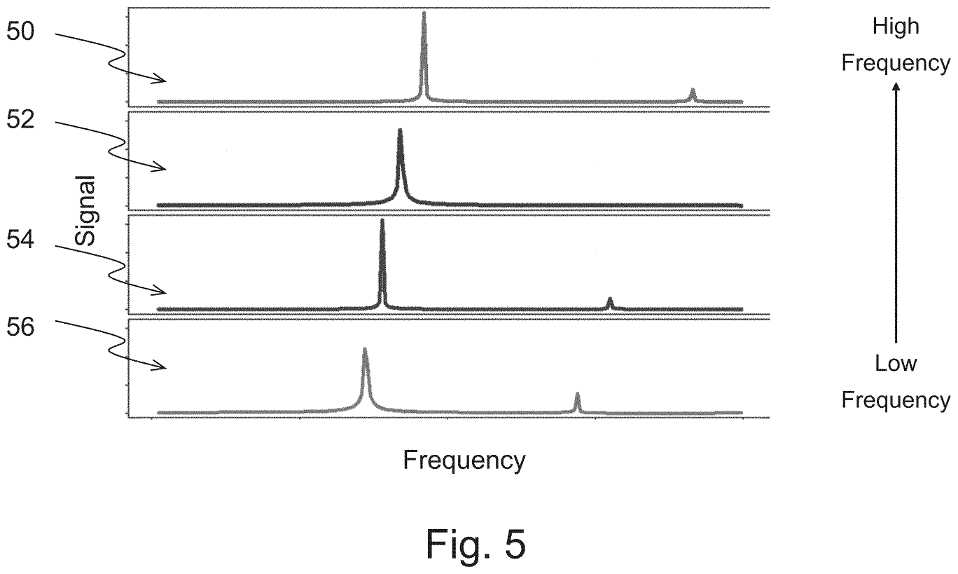

The penetration of an ion into the electrode regions of the electrostatic ion trap may affect the ion oscillation frequency. FIG. 4 shows representative graphs of ion signal intensity against time (i.e. CDMS data representative of ion oscillation frequency in the time domain). FIG. 5 shows representative graphs of ion signal intensity against frequency (i.e. CDMS data representative of ion oscillation frequency in the frequency domain). Graphs 40 and 50 show representative graphs of a high ion oscillation frequency, and graphs 46 and 56 show representative graphs of a low ion oscillation frequency. Graphs 42, 44, 52, and 54 show representative graphs of intermediate ion oscillation frequencies. As shown by the detection signals 40″, 42″, 44″, 46″, the time of detection may remain consistent independent of the frequency of the ion oscillation; it may be the time spent in the electrode regions of the electrostatic ion trap, i.e. the non-detected regions 40′, 42′, 44′, 46′, that is changed by the voltage maps, changing the ion oscillation frequency. Additionally or alternatively, the penetration of the ion into the electrode regions of the electrostatic ion trap may be altered by changing the ion energy (e.g. by changing the first ion energy to a second ion energy), which may result in the change of ion oscillation frequency as described above.

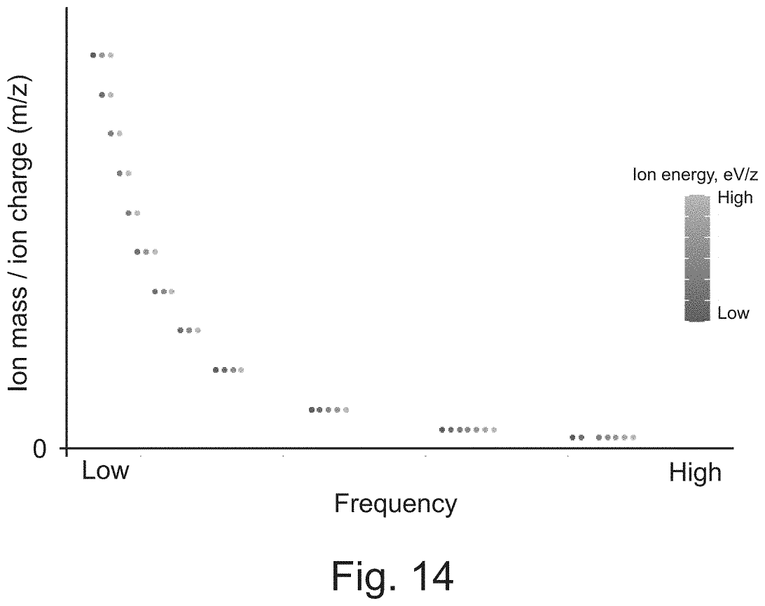

As described above, and with reference to FIGS. 7, 10, and 11, the CDMS may be operated using numerous (e.g. at least two) voltage maps. These maps may be chosen to eliminate or reduce interferences with persistent background frequency components if the ion m/z is known. A typical example may begin by loading a default voltage configuration (i.e. the first voltage map). This default voltage configuration will result in ions of a given m/z value exhibiting a characteristic frequency as part of the first CMDS data indicative of the first ion oscillation frequency. If this first ion oscillation frequency lands on or near a persistent background peak (i.e. a region of relatively high-intensity background noise), this interference is detected and the voltage map may be changed from the first voltage map to the second voltage map, to shift the m/z to frequency relationship (i.e. change the first ion oscillation frequency to the second ion oscillation frequency). The same effect as described above may be achieved by changing the first ion energy to a second ion energy (i.e. tuning the ion energy), as shown in FIG. 14.

A single voltage map (e.g. the first voltage map) may produce stable ion trajectories and ion oscillation frequencies over a range of ion energies. This ion energy may be shifted by tuning the voltages of the electrodes at an atmospheric pressure interface region (i.e. the ion inlet into the electrostatic ion trap). The trap's voltage configuration may require tuning to compensate for the change in ion energy. In this way, an ion of interest may be shifted to a region of the frequency spectrum that is uncontaminated by background noise peaks (e.g. region(s) of relatively high-intensity background noise), thus improving charge measurement and mass assignment.

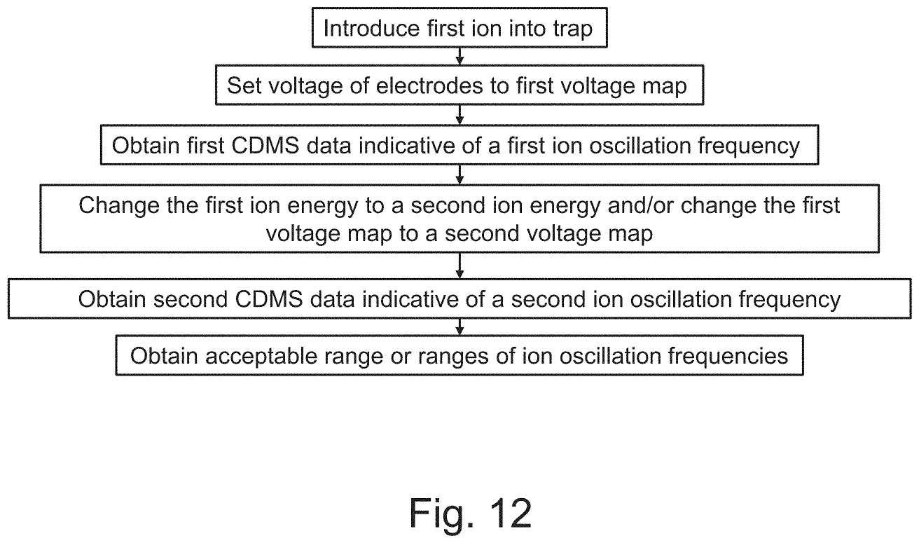

As shown in FIG. 12, the method may include performing the following steps in the following order:
e) changing the first ion energy to a second ion energy and/or changing the first voltage map to a second voltage map,
f) obtaining second CDMS data indicative of a second ion oscillation frequency, and
d) obtaining an acceptable range or ranges of ion oscillation frequencies.

As described above, the method for detecting interfering frequencies and tuning the electrostatic ion trap may include cycling through a series of two (or more) voltage maps or ion energies. Frequency domain signals that derive from trapped ions will shift frequency by a predictable amount when the voltage map and/or ion energies are changed. Frequency domain signals that derive from interferences (i.e. regions of relatively high-intensity background noise) may not. Additionally, these frequency domain signals derived from trapped ions under different conditions (e.g. voltage maps and/or ion energies) may be useful in eliminating systematic errors. This may reduce the need for prior knowledge of interferences.

The obtaining an acceptable range or ranges of ion oscillation frequencies may include determining a range or ranges of relatively high-intensity background noise that lie(s) in a same range or ranges in the first CDMS data and the second CDMS data. Obtaining an acceptable range or ranges of ion oscillation frequencies as described above may provide advantages. In particular, a range or ranges of relatively high-intensity background noise may be determined whilst the first CDMS data indicative of the first ion oscillation frequency and second CDMS data indicative of the second ion oscillation frequency are being obtained. This may result in time saved compared to known methods of identifying background noise when no ion is present in the electrostatic ion trap as described above. Accordingly, obtaining an acceptable range or ranges of ion oscillation frequencies as described above may be useful for determining such a range or ranges that remain at the same frequency range or ranges when changing ion oscillation frequencies (e.g. from the first ion oscillation frequency to the second ion oscillation frequency). Further, determining a range or ranges of relatively high-intensity background noise that lie(s) in a same range or ranges in the first CDMS data and the second CDMS data may allow for identification of areas of relatively high-intensity background noise that might shift in frequency due to the presence of an ion within the electrostatic ion trap.

The acceptable range or ranges of frequencies may be a resonant frequency range or ranges of an amplification device connected to a detection tube 32 of the electrostatic ion trap. When obtaining an acceptable range or ranges of ion oscillation frequencies in this way, changing the first ion energy to a second ion energy and/or changing the first voltage map to a second voltage map may result in the second ion oscillation frequency being within the resonant frequency of an amplification device, such that the signal intensity representative of the ion is amplified. Therefore, the time required to analyse an ion may be reduced, and/or the measurement accuracy of the CDMS data representative of the second ion oscillation frequency may be increased. Additionally or alternatively, when obtaining an acceptable range or ranges of ion oscillation frequencies in this way, changing the first ion energy to a second ion energy and/or changing the first voltage map to a second voltage map may result in the second ion oscillation frequency being outside of the range or ranges of relatively high-intensity background noise as well as within the resonant frequency of the amplification device. This may allow for the second CDMS data indicative of a second ion oscillation frequency to be both amplified and be unaffected by background noise. Accordingly, measurements obtained using the method as described herein may result in high quality measurements, e.g. confidence in the accuracy of the second CDMS data may be increased (e.g. confidence that the ion oscillation frequency (and/or ion mass-to-charge ratio (m/z), and/or ion charge (z), and/or ion mass (m)) data is accurate.

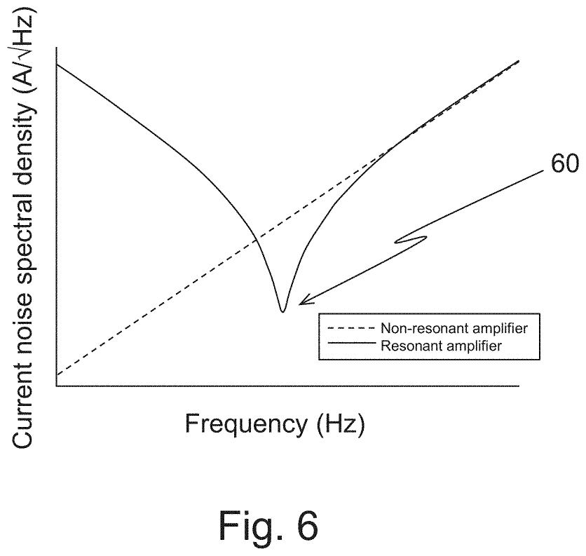

As shown in FIG. 6, the resonant frequency of an amplifier may be a frequency or range of frequencies where the signal to noise ratio is high, e.g. the frequency at which optimal signal to noise ratio 60 is present.

The amplification device may have a plurality of selectable resonant amplification frequency range or ranges. Amplification devices having a plurality of selectable resonant amplification frequencies may allow for flexibility in the second voltage map that is selected and/or the second ion energy that is selected. In particular, in the event one of the plurality of resonant amplification frequencies is located in a region of relatively high-intensity background noise, then the second voltage map that is selected and/or the second ion energy may be chosen such that the second ion oscillation frequency lies within a resonant amplification frequency range or ranges located away from the region of relatively high-intensity background noise.

The amplification device may comprise an amplifier with a plurality of resonant amplification frequency range or ranges, and/or an array of a plurality of selectable amplifiers, each selectable amplifier having a resonant amplification frequency range or ranges.

Amplification devices comprising an amplifier with a plurality of resonant amplification frequency range or ranges, and/or an array of a plurality of selectable amplifiers, each selectable amplifier having a resonant amplification frequency range or ranges, as described above may provide advantages. In particular, as described above, in the event one of the plurality of resonant amplification frequencies is located in a region of relatively high-intensity background noise, then the second voltage map that is selected and/or the second ion energy may be chosen such that the second ion oscillation frequency lies within a resonant amplification frequency range or ranges located away from the region of relatively high-intensity background noise.

The changing the first ion energy to a second ion energy may be achieved by introducing a second ion at the second ion energy.

The method may include ramping the first voltage map to the second voltage map over a period of from 0.2 milliseconds to 10 milliseconds. This approach may allow the ion's trajectory to relax into the constantly shifting electrostatic ion trap potential, ensuring that stable trajectory may be maintained while the voltage map is changed (i.e. from the first to the second voltage map).

The first ion oscillation frequency may be determined by performing a fast Fourier transform on the first CDMS data (as shown in FIGS. 7 to 10) and/or the second ion oscillation frequency may be determined by performing a fast Fourier transform on the second CDMS data.

The method of operating a charge detection mass spectrometer (CDMS) may further include changing the second ion energy to a third ion energy and/or changing the second voltage map to a third voltage map, and obtaining third CDMS data indicative of a third ion oscillation frequency. Accordingly, the ion oscillation frequency (i.e. of the first or second, or third ion, if present) may be analysed and relatively high-intensity background noise regions may be avoided, and/or the third map may result in the first, second, or third, if present, ion oscillation frequency being within the amplification resonant frequency range or ranges.

The third ion oscillation frequency may be determined by performing a fast Fourier transform on the third CDMS data.

If the ion is within an electric field-free region of the trap (i.e. the detection tube 32) during a change from the first voltage map to the second voltage map ramp, the trajectory of the ion may not be not impacted until it exits the field-free region. Choosing voltage maps that not only shift the frequency of the ion (e.g. the first ion, or second ion) to a resonant frequency of the amplification device, but also tolerate a wide range of initial ion conditions (i.e. energy in dimensions orthogonal to the trap, positional offset from the trap axis, etc.) may improve the likelihood of imparting a successful ion oscillation frequency shift.

The method may include ramping the second voltage map to the third voltage map over a period of from 0.2 milliseconds to 10 milliseconds. This approach may allow the ion's trajectory to relax into the constantly shifting electrostatic ion trap potential, ensuring that stable trajectory may be maintained while the voltage map is changed (i.e. from the first to the second voltage map).

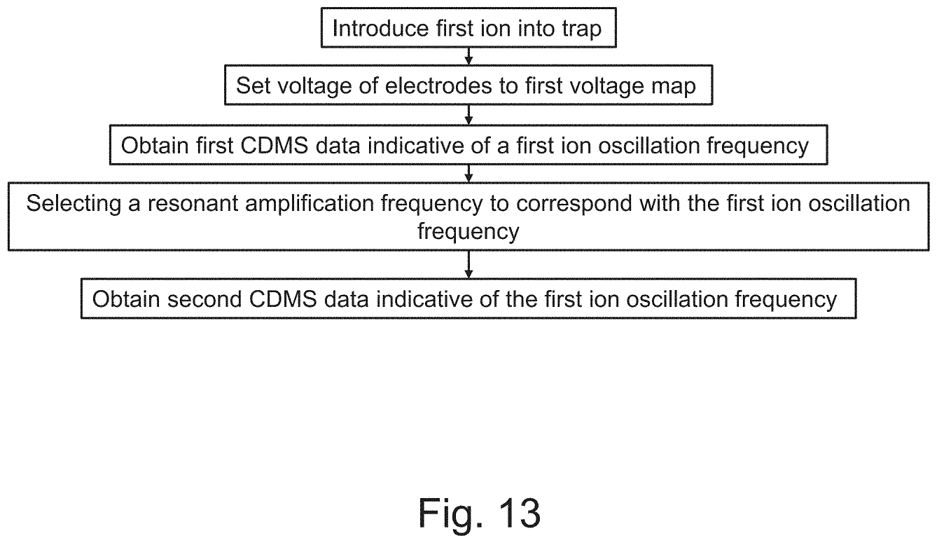

With reference to FIG. 13, there is also provided a method of operating a charge detection mass spectrometer (CDMS), the CDMS comprising:
an electrostatic ion trap comprising a plurality of electrodes 30, 70,
a detection tube 32, 72, and
an amplification device connected to the detection tube 32, 72 having a plurality of selectable resonant amplification frequency range or ranges, wherein the method comprises:
a) introducing a first ion into the electrostatic ion trap at a first ion energy,
b) setting the voltage of the plurality of electrodes 30, 70 to a first voltage map,
c) obtaining first CDMS data indicative of a first ion oscillation frequency,
d) selecting the resonant amplification frequency range or ranges to correspond with the first ion oscillation frequency, and
e) obtaining second CDMS data indicative of the first ion oscillation frequency.

The detection tube may include a detector configured to detect the presence of an ion in the electrostatic ion trap. The amplification device may comprise an amplifier with a plurality of selectable resonant amplification frequency ranges, and/or an array of at least two selectable amplifiers 76, each selectable amplifier 76 having a resonant amplification frequency range or ranges. The amplifier may amplify the signal output by the detector. Detection electronics (e.g. the amplification device) can be designed to selectively amplify resonant frequencies. This may be achieved with a combination of a capacitor and inductor at the front end of the amplification device (e.g. the front end of the amplifier and/or the selectable amplifiers); additionally or alternatively this may be achieved with quartz crystal connected to the amplification device (e.g. quartz crystal(s) connected to the amplifier and/or the selectable amplifiers). Additionally or alternatively, each amplifier (e.g. each selectable amplifier) could be constructed with different crystals each of which may provide different resonant frequencies. These individual amplifiers may be connected to a detector with a low capacitance switch. This configuration may cover a wider frequency range than a single amplifier of a single frequency. Similarly, an array of crystals may be connected to the front end of the amplifier to produce an amplifier with a plurality of selectable resonant amplification frequency ranges.

At least one of the plurality of selectable amplifiers 76 may be a resonant amplifier having a resonant amplification frequency range or ranges.

At least one of the plurality of selectable amplifiers 76 may be a non-resonant amplifier.

Methods of operating a charge detection mass spectrometer (CDMS) as described above may provide advantages. In particular, if it is determined that the first CDMS data indicative of a first ion oscillation frequency, and therefore the resulting ion oscillation frequency, is at a desired value (e.g. the first ion oscillation frequency is not located in a region of relatively high-intensity background noise), then the resonant amplification frequency is selected to correspond with the first ion oscillation frequency. Therefore, there may be a reduced need, or no need, to change the operating parameters of the electrostatic ion trap (e.g. ion energy or voltage map) in order to amplify signals representative of the first ion (e.g. the first ion oscillation frequency). Further, the amplification device having a plurality of (e.g. at least two) selectable resonant frequencies may increase the potential frequencies that may be amplified, and therefore may be subsequently highly adaptable to various ion oscillation frequencies. Furthermore, providing an amplification device having at least two selectable resonant frequencies may provide further advantages. In particular, since the resonant frequency may be selected to correspond with the first ion oscillation frequency, a more accurate measurement (e.g. more accurate second CDMS data indicative of the first ion oscillation frequency) may be made in the same sampling time as known methods, or additionally or alternative, an equally accurate measurement may be made in a shorter sampling time. Obtaining an equally accurate measurement in a shorter sampling time may be particularly advantageous in reducing sampling time, such that potential for collisions between the first ion and background gas molecules (if present) may be reduced. The more accurate measurement or equally accurate measurement than known methods as described above may be obtained by the CDMS data indicative of the first ion oscillation frequency having a higher signal (i.e. signal representative of an ion) to noise ratio than known methods.

The method may further include:
g) changing the first ion energy to a second ion energy and/or changing the first voltage map to a second voltage map,
h) obtaining third CDMS data indicative of a second ion oscillation frequency,
i) selecting the resonant amplification frequency range or ranges to correspond with the second first ion oscillation frequency,
j) obtaining fourth CDMS data indicative of the second ion oscillation frequency.

Changing the first ion energy to a second ion energy may include by introducing a second ion into the electrostatic ion trap at the second ion energy.

Methods of operating a charge detection mass spectrometer (CDMS) as described above may provide advantages. In particular, the first ion oscillation frequency may be determined and amplified, the frequency may be shifted by changing the voltage map or ion energy, and then the second ion oscillation frequency may be determined and amplified; this may allow for confirmation of the existence (or non-existence), of a region(s) of relatively high-intensity background noise around the first ion oscillation frequency.

### Exemplary Methods of Operating a Charge Detection Mass Spectrometer (CDMS)

The following examples are exemplary methods of operating a charge detection mass spectrometer (CDMS) and are provided for illustrative purposes; the following examples are not intended to limit the scope of the methods solely to the following examples.

With reference to FIG. 7, the method of operating a charge detection mass spectrometer (CDMS) may include the following steps. An ion trapping event may be initiated (e.g. introducing a first ion into an electrostatic ion trap at a first ion energy); the ion trapping event may be initiated using an ion introduction voltage map (e.g. setting the voltage of a plurality of electrodes within the electrostatic ion trap to an introduction voltage map). The setting the voltage of the plurality of electrodes may then be set to a first voltage map (not shown in FIG. 7). First CDMS data indicative of a first ion oscillation frequency may be acquired (the first CDMS data may include data such as ion oscillation frequency and/or ion mass-to-charge ratio (m/z), and/or ion charge (z), and/or ion mass (m)). The first CDMS data may be obtained after a delay (e.g. to allow for an ion, if trapped, to oscillate and generate a signal). The first CDMS data may then be analysed to determine if an ion has been trapped (i.e. if an ion is oscillating within the electrostatic ion trap). If an ion has been determined to not have been trapped, the method may be restarted; if an ion has been determined to have been trapped, the method may be continued. Determination of whether the ion is oscillating at an acceptable frequency may be carried out (e.g. by analysing the first CDMS data). The background spectrum may be analysed during the ion trapping event and/or the determination of whether the ion is oscillating at an acceptable frequency. If it determined that the ion is oscillating at an acceptable frequency, second CDMS data (e.g. indicative of a first ion oscillation frequency) may be acquired; if it is determined that the ion is not oscillating at an acceptable frequency, then the voltage map may be changed (e.g. the first voltage map may be changed to a second voltage map, and the method as above may be repeated using the second voltage map).

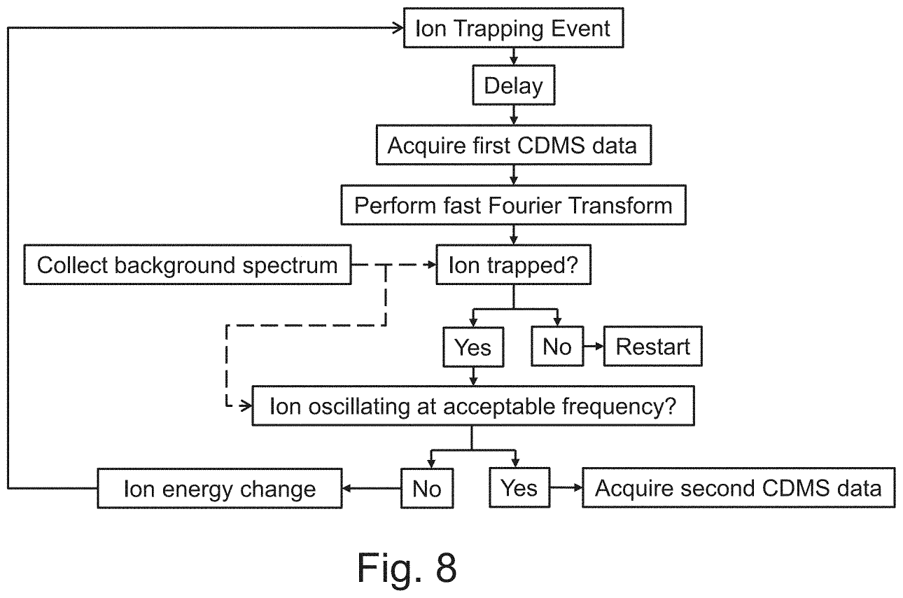

With reference to FIG. 8, the method of operating a charge detection mass spectrometer (CDMS) may include the following steps. An ion trapping event may be initiated (e.g. introducing a first ion into an electrostatic ion trap at a first ion energy); the ion trapping event may be initiated using an ion introduction voltage map (e.g. setting the voltage of a plurality of electrodes within the electrostatic ion trap to an introduction voltage map). The setting the voltage of the plurality of electrodes may then be set to a first voltage map (not shown in FIG. 8). First CDMS data indicative of a first ion oscillation frequency may be acquired (the first CDMS data may include data such as ion oscillation frequency and/or ion mass-to-charge ratio (m/z), and/or ion charge (z), and/or ion mass (m)). The first CDMS data may be obtained after a delay (e.g. to allow for an ion, if trapped, to oscillate and generate a signal). The first CDMS data may then be analysed to determine if an ion has been trapped (i.e. if an ion is oscillating within the electrostatic ion trap), e.g. by performing a fast-Fourier transform to determine the ion's oscillation frequency. If an ion has been determined to not have been trapped, the method may be restarted; if an ion has been determined to have been trapped, the method may be continued. Determination of whether the ion is oscillating at an acceptable frequency may be carried out (e.g. by analysing the first CDMS data). The background spectrum may be analysed during the ion trapping event and/or the determination of whether the ion is oscillating at an acceptable frequency. If it determined that the ion is oscillating at an acceptable frequency, second CDMS data (e.g. indicative of a first ion oscillation frequency) may be acquired; if it is determined that the ion is not oscillating at an acceptable frequency, then the ion energy may be changed as described above (e.g. the first ion energy may be changed to a second ion energy, and the method as above may be repeated using the second ion energy). To achieve the voltage change, a voltage ramp may initiated on a set of electrodes to change the voltage configuration of the trap; this may change the oscillation frequency of the ion.

With reference to FIG. 9, the method of operating a charge detection mass spectrometer (CDMS) may include the following steps. An ion trapping event may be initiated (e.g. introducing a first ion into an electrostatic ion trap at a first ion energy); the ion trapping event may be initiated using an ion introduction voltage map (e.g. setting the voltage of a plurality of electrodes within the electrostatic ion trap to an introduction voltage map). The setting the voltage of the plurality of electrodes may then be set to a first voltage map (not shown in FIG. 9). First CDMS data indicative of a first ion oscillation frequency may be acquired (the first CDMS data may include data such as ion oscillation frequency and/or ion mass-to-charge ratio (m/z), and/or ion charge (z), and/or ion mass (m)). The first CDMS data may be obtained after a delay (e.g. to allow for an ion, if trapped, to oscillate and generate a signal). The first CDMS data may then be analysed to determine if an ion has been trapped (i.e. if an ion is oscillating within the electrostatic ion trap), e.g. by performing a fast-Fourier transform to determine the ion's oscillation frequency. If an ion has been determined to not have been trapped, the method may be restarted; if an ion has been determined to have been trapped, the method may be continued. Determination of whether the ion is oscillating in a range or ranges of high intensity background noise may be carried out (e.g. by analysing the first CDMS data). The background spectrum may be analysed during the ion trapping event and/or the determination of whether the ion is oscillating in a range or ranges of high-intensity background noise. If it determined that the ion is not oscillating in a range or ranges of high intensity background noise, second CDMS data (e.g. indicative of a first ion oscillation frequency) may be acquired; if it is determined that the ion is oscillating in a range or ranges of high intensity background noise, then the voltage map may be changed (e.g. the first voltage map may be changed to a second voltage map, and the method as above may be repeated using the second voltage map). To achieve the voltage change, a voltage ramp may initiated on a set of electrodes to change the voltage configuration of the trap; this may change the oscillation frequency of the ion.

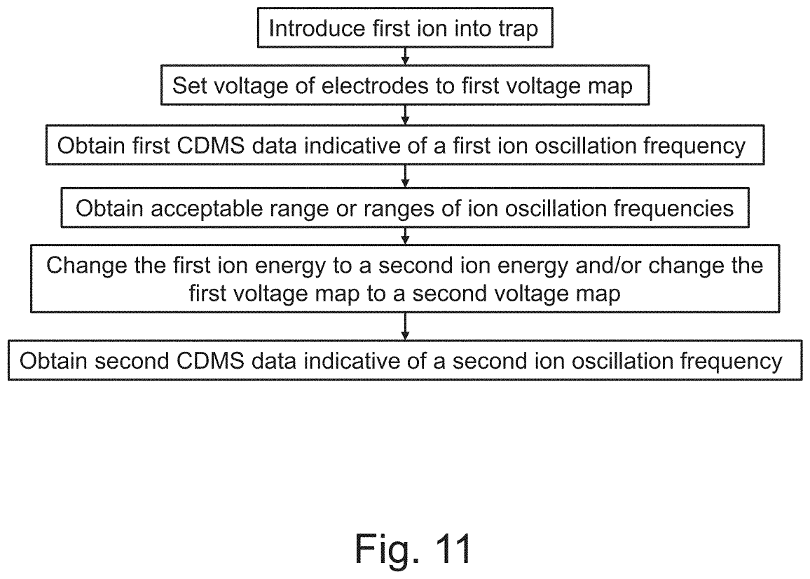

With reference to FIG. 10, the method of operating a charge detection mass spectrometer (CDMS) may include the following steps. An ion trapping event may be initiated (e.g. introducing a first ion into an electrostatic ion trap at a first ion energy); the ion trapping event may be initiated using an ion introduction voltage map (e.g. setting the voltage of a plurality of electrodes within the electrostatic ion trap to an introduction voltage map). The setting the voltage of the plurality of electrodes may then be set to a first voltage map (not shown in FIG. 11). First CDMS data indicative of a first ion oscillation frequency may be acquired (the first CDMS data may include data such as ion oscillation frequency and/or ion mass-to-charge ratio (m/z), and/or ion charge (z), and/or ion mass (m)). The first CDMS data may be obtained after a delay (e.g. to allow for an ion, if trapped, to oscillate and generate a signal). The first CDMS data may then be analysed to determine if an ion has been trapped (i.e. if an ion is oscillating within the electrostatic ion trap), e.g. by performing a fast-Fourier transform to determine the ion's oscillation frequency. If an ion has been determined to not have been trapped, the method may be restarted; if an ion has been determined to have been trapped, the method may be continued. Determination of whether the ion is oscillating in a range or ranges of high intensity background noise may be carried out (e.g. by analysing the first CDMS data). The background spectrum may be analysed during the ion trapping event and/or the determination of whether the ion is oscillating in a range or ranges of high-intensity background noise. If it determined that the ion is not oscillating in a range or ranges of high intensity background noise, second CDMS data (e.g. indicative of a first ion oscillation frequency) may be acquired; if it is determined that the ion is oscillating in a range or ranges of high intensity background noise, then the ion energy may be changed as described above (e.g. the first ion energy may be changed to a second ion energy, and the method as above may be repeated using the second ion energy).

With reference to FIG. 11, the method of operating a charge detection mass spectrometer (CDMS) may include the following steps: introducing a first ion into the electrostatic ion trap at a first ion energy, setting the voltage of the plurality of electrodes to a first voltage map, obtaining first CDMS data indicative of a first ion oscillation frequency, obtaining an acceptable range or ranges of frequencies; and if the first ion oscillation frequency is outside the acceptable range or ranges of frequencies: changing the first ion energy to a second ion energy and/or changing the first voltage map to a second voltage map, and obtaining second CDMS data indicative of a second ion oscillation frequency.

With reference to FIG. 12, the method of operating a charge detection mass spectrometer (CDMS) may include the following steps: introducing a first ion into the electrostatic ion trap at a first ion energy, setting the voltage of the plurality of electrodes to a first voltage map, obtaining first CDMS data indicative of a first ion oscillation frequency, changing the first voltage map to a second voltage map, and obtaining second CDMS data indicative of a second ion oscillation frequency, obtaining second CDMS data indicative of a second ion oscillation frequency, and obtaining an acceptable range or ranges of frequencies.

With reference to FIG. 13, the method of operating a charge detection mass spectrometer (CDMS) may include the following steps: introducing a first ion into the electrostatic ion trap at a first ion energy, setting the voltage of the plurality of electrodes to a first voltage map, obtaining first CDMS data indicative of a first ion oscillation frequency, setting a resonant amplification frequency (e.g. by using an amplification device as described herein), and obtaining second CDMS data indicative of a second ion oscillation frequency.

There is also provided a charge detection mass spectrometer (CDMS) for carrying out the method(s) as described herein, comprising:
an electrostatic ion trap comprising at least two electrodes 30, 70 configurable to be set to a voltage map;
a detection tube 32, 72; and
an amplification device connected to the detection tube,
the amplification device having a plurality of selectable resonant amplification frequencies.

The CDMS as described above may be used, and have any, or any combination, or all, of the corresponding advantages of any of, or any combination of, or all of, the method(s) as described herein.

The CDMS may include a plurality of detection tubes 72.

As shown in FIG. 6, resonant amplifiers 76 may have a limited frequency range over which they exhibit low noise and high signal-to-noise ratios. When electrosprayed, complex samples consisting of large, heterogeneous molecules, particles, and molecular assemblies may produce ions with a broad range of m/z ratios. Ions oscillate at a frequency proportional to (m/z)⁻¹ meaning that heterogeneous samples with broad m/z distributions may oscillate at many different frequencies. If these signals are amplified with a single resonant amplifier 76, there may be no guarantee that an ion's oscillation frequency will be within the resonant frequency band of the resonant amplifier.

Including two or more (i.e. a plurality of) detection tubes 72, as described above, may provide advantages. The detection tubes 72 may be arranged along the central axis of the electrostatic ion trap (e.g. the electrostatic linear ion trap or the cone trap). These detection tubes 72 may be assembled into a mechanical assembly or fabricated on a circuit board.

The amplification device may comprise an amplifier with a plurality of selectable resonant amplification frequency ranges. The amplification device may comprise an array of a plurality of selectable amplifiers 76, each selectable amplifier having a resonant amplification frequency range or ranges. The plurality of selectable amplifiers 76 may be connected to each of the plurality of detection tubes 72.

In other words, each detection tube 72 may be connected (e.g. electrically connected) to its own, dedicated amplifier 76 (e.g. a resonant amplifier) that may be tuned to a unique resonant frequency range or ranges (for example, as shown in FIG. 6). Each channel may be independently digitized (e.g. by using an analogue to digital converter 74 and recorded. This may enable resonant amplification using multiple resonant amplifiers that have been tuned to different frequency range or ranges enabling the sensitive, low-noise detection of ions with various oscillation frequencies. Further, flexibility of a voltage map or ion energy that may be selected may be increased, e.g. there may be multiple frequencies that an ion may oscillate at and be amplified (since there may be a plurality of possible ranges of resonant frequencies that may be selected from)

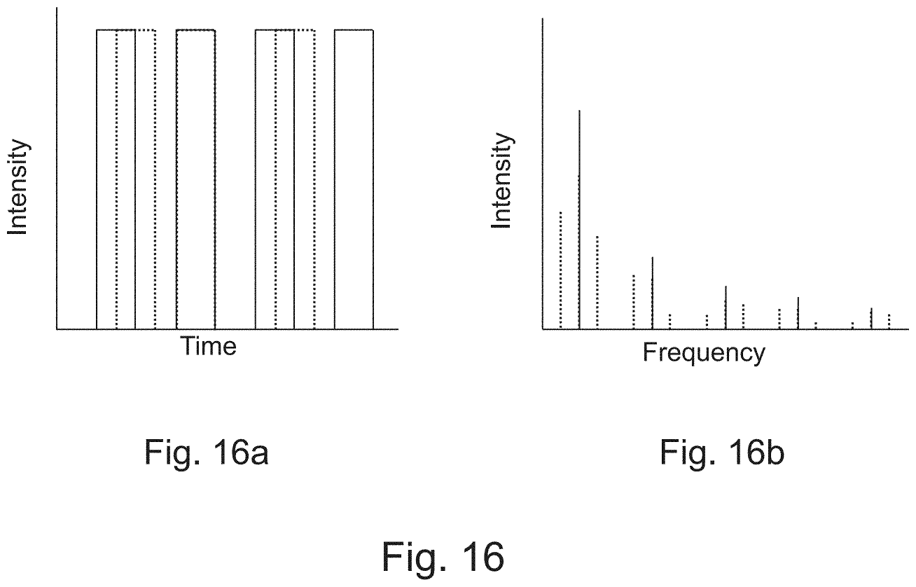

The harmonic ratios of CDMS data representative of ion(s) may be altered depending upon the position of the detection tube(s). This may reduce the amplitude of the fundamental peak. FIG. 16a shows a graph of ion signal intensity against time. The solid line shows a signal of an ion traveling through a detection tube 72 located centrally in the electrostatic ion trap. The dashed line shows a signal of the same ion traveling through a detection tube 72 located off-centre of the electrostatic ion trap (e.g. closer to one end of the electrostatic ion trap than the other). As is shown by the solid line in the graph of FIG. 16a, the amount of time the ion spends inside the detection cylinder is equal to the amount of time the ion spends outside the detection tube in the example. The waveform resulting from a detection tube of the same length being positioned off-centre (dashed line) may result in a asymmetric waveform. In particular, the ion may spend 1.5 times the amount of time outside the detection tube as it does inside the detection tube on one side of the trap and 0.5 times the amount of time outside the detection tube as it does inside the detection tube on the other side of the trap. Accordingly, as shown by FIG. 16b, there may be a range of frequencies at a lower signal intensity resultant from detection of the off-centre detection tube (i.e. more detected oscillation frequencies than the centrally located detection tube). However, the gains made by resonant amplification (e.g. by using an amplifier 76, such as a resonant amplifier) may overcome this effect. Further, multiple amplifiers simultaneously connected to a single detection tube may interfere with each other, which may result in an increased number or amplitude of region(s) of relatively high-intensity background noise; when the plurality of selectable amplifiers 76 are connected to each of the plurality of detection tubes 72 (e.g. one selectable amplifier 76 electrically connected to one detection tube 72), the amplification and interference effects may be reduced and/or minimised.

At least one of the plurality of selectable amplifiers 76 may be a resonant amplifier.

At least one of the plurality of selectable amplifiers 76 may be a non-resonant amplifier.

In other words, one or more detection tube(s) may optionally be connected to a conventional (non-resonant) amplifier. This may prove useful in calibrating the instrument's response across a wide mass-to-charge ratio range. In particular, a conventional amplifier may allow for determination of region(s) of relatively high-intensity background noise to a high degree of accuracy (e.g. by amplifying the region(s) of relatively high-intensity background noise), and/or may allow for determination of an ion oscillation frequency (such that a resonant amplification frequency may be selected by selecting a selectable amplifier 76 with a resonant frequency within the range or ranges of ion oscillation frequencies).

The CDMS may further include at least one refocusing optic (not shown) between each of the plurality of detection tubes 72.

Refocusing optics may be positioned between each detection tube 72 to keep ions within the detection tube(s) 72 to prevent ion loss (e.g. the ion hitting a wall of the detection tube(s) 72).

An array of detection tubes may be arranged in a circle with refocusing/deflecting optics (not shown), and each detection tube may include its own resonant or non-resonant amplifier. Individual refocusing/deflecting optics may comprise magnetic fields to assist in deflecting the ions or a magnet assembly may impose a magnetic field on the entire array of pickup tubes. One of the refocusing/deflecting optics assemblies may comprise a means for introducing ions into the assembly. Another refocusing/deflecting optics assembly may optionally comprise a means for ions to exit the assembly. Such an example may not require the reflecting elements as described above. Additionally, the detection tubes might be bent tubes or comprise multiple elements.

There is also provided a computer readable medium having instructions stored thereon which, when executed by a processor, cause the performance of a method of operating a charge detection mass spectrometer (CDMS) as described above.

There is also provided a computer program comprising instructions which, when executed by a processor, cause the performance of a method of operating a charge detection mass spectrometer (CDMS) as described above.

There is also provided a system comprising at least one processor and a computer readable medium, wherein the computer readable medium has instructions stored thereon which, when executed by the at least one processor, cause the system to perform a method of operating a charge detection mass spectrometer (CDMS) as described above.

The computer readable media may be configured to store instructions for execution by the processor. The processor(s) may include a number of sub-processors which may be configured to work together, e.g. in parallel with each other, to execute the instructions. The sub-processors may be geographically and/or physically separate from each other and may be communicatively coupled to enable coordinated execution of the instructions.

The computer readable media may be any desired type or combination of volatile and/or non-volatile memory such as, for example, static random access memory (SRAM), dynamic random access memory (DRAM), flash memory, read-only memory (ROM), and/or a mass storage device (including, for example, an optical or magnetic storage device).

The system and/or the charge detection mass spectrometer (CDMS) including the processor and computer readable medium, may be provided in the form of a server, a desktop computer, a laptop computer, or the like.

Further examples are provided below and may be applied to any of, any combination of, or all of the method(s), the CDMS, the computer readable medium, the computer program, and/or the system as described above.

The changing the first voltage map to the second voltage map may be achieved when the first ion is in an electric-field-free region of the electrostatic ion trap (for example, when the ion is in the detection tube 32, 72).

Setting the voltage of the plurality of electrodes 30, 70 to a first voltage map and/or changing the first voltage map to a second voltage map may include setting at least one electrode 30, 70 to 0 volts.

Setting the voltage of the plurality of electrodes 30, 70 to a first voltage map and/or changing the first voltage map to a second voltage map may include turning off at least one electrode 30, 70.

Setting the voltage of the plurality of electrodes 30, 70 to a first voltage map and/or changing the first voltage map to a second voltage map may include setting at least one electrode 30, 70 to a negative voltage.

The method may further include subtracting the high-intensity background noise from the CDMS data (e.g. the first CDMS data, the second CDMS data, the third CDMS data, if present, and/or the fourth CDMS data, if present.

The electrostatic ion trap may include at least 6 electrodes 30, 70; or at least 10 electrodes 30, 70; or at least 16 electrodes 30, 70; at least 20 electrodes 30, 70; at least 50 electrodes 30, 70; or at least 100 electrodes 30, 70. In other words, trap geometry can be utilized to make a trap widely tunable to enable access to a broad range of ion oscillation frequencies. Conceptually, any number of electrodes could be utilized to construct an electrostatic ion trap. Certain regions of the trap could effectively be shut off or turned on depending on the voltage configuration (as shown in FIG. 3). This may enable a wider range of frequencies to be accessed.

The electrostatic ion trap may be a cone trap.

The electrostatic ion trap may be an electrostatic linear ion trap.

There is also provided a method of operating a charge detection mass spectrometer (CDMS),

the CDMS comprising an electrostatic ion trap and the electrostatic ion trap comprising a plurality of electrodes,
the method comprising:
introducing a first ion into the electrostatic ion trap at a first ion energy,
setting the voltage of the plurality of electrodes to a first voltage map,
obtaining first CDMS data indicative of a first ion oscillation frequency,
obtaining an acceptable range or ranges of frequencies;

if the first ion oscillation frequency is outside the acceptable range or ranges of frequencies:
changing the first ion energy to a second ion energy and/or changing the first voltage map to a second voltage map, and
obtaining second CDMS data indicative of a second ion oscillation frequency.

The optional features (and resultant advantages) of any of, any combination of, or all of the method(s), the CDMS, the computer readable medium, the computer program, and/or the system as described above may be included in the method as described above.

When used in this specification and claims, the terms “comprises” and “comprising” and variations thereof mean that the specified features, steps or integers are included. The terms are not to be interpreted to exclude the presence of other features, steps or components.

The invention may also broadly consist in the parts, elements, steps, examples and/or features referred to or indicated in the specification individually or collectively in any and all combinations of two or more said parts, elements, steps, examples and/or features. In particular, one or more features in any of the embodiments described herein may be combined with one or more features from any other embodiment(s) described herein.

Protection may be sought for any features disclosed in any one or more published documents referenced herein in combination with the present disclosure.

Although certain example embodiments of the invention have been described, the scope of the appended claims is not intended to be limited solely to these embodiments. The claims are to be construed literally, purposively, and/or to encompass equivalents.

1. A method of operating a charge detection mass spectrometer (CDMS),
the CDMS comprising an electrostatic ion trap, the electrostatic ion trap comprising a plurality of electrodes,
the method comprising:
a) introducing a first ion into the electrostatic ion trap at a first ion energy,
b) setting the voltage of the plurality of electrodes to a first voltage map,
c) obtaining first CDMS data indicative of a first ion oscillation frequency,
d) obtaining an acceptable range or ranges of ion oscillation frequencies,
e) changing the first ion energy to a second ion energy and/or changing the first voltage map to a second voltage map, and
f) obtaining second CDMS data indicative of a second ion oscillation frequency.

2. The method of operating a charge detection mass spectrometer (CDMS) according to claim 1, wherein the method comprises performing the following steps in the following order:
d) obtaining an acceptable range or ranges of ion oscillation frequencies,
e) changing the first ion energy to a second ion energy and/or changing the first voltage map to a second voltage map, and
f) obtaining second CDMS data indicative of a second ion oscillation frequency.

3. The method of operating a charge detection mass spectrometer (CDMS) according to claim 1, wherein the obtaining an acceptable range or ranges of ion oscillation frequencies comprises obtaining a range or ranges known to include relatively low-intensity background noise under the conditions used to obtain the first CDMS data.

4. The method of operating a charge detection mass spectrometer (CDMS) according to claim 1, wherein the second ion oscillation frequency is a frequency within the acceptable range or ranges of ion oscillation frequencies.

5. The method of operating a charge detection mass spectrometer (CDMS) according to claim 1, wherein the method comprises performing the following steps in the following order:
e) changing the first ion energy to a second ion energy and/or changing the first voltage map to a second voltage map,
f) obtaining second CDMS data indicative of a second ion oscillation frequency, and
d) obtaining an acceptable range or ranges of ion oscillation frequencies; and
wherein the obtaining an acceptable range or ranges of ion oscillation frequencies comprises determining a range or ranges of relatively high-intensity background noise that lie(s) in a same range or ranges in the first CDMS data and the second CDMS data.

6. The method of operating a charge detection mass spectrometer (CDMS) according to claim 1, wherein the acceptable range or ranges of frequencies is a resonant frequency range or ranges of an amplification device connected to a detection tube of the electrostatic ion trap.

7. The method of operating a charge detection mass spectrometer (CDMS) according to claim 6, wherein the amplification device has a plurality of selectable resonant amplification frequency range or ranges.

8. The method of operating a charge detection mass spectrometer (CDMS) according to claim 7 wherein the amplification device comprises:
an amplifier with a plurality of resonant amplification frequency range or ranges, and/or
an array of a plurality of selectable amplifiers, each selectable amplifier having a resonant amplification frequency range or ranges.

9. The method of operating a charge detection mass spectrometer (CDMS) according to claim 1, wherein the method comprises changing the first voltage map to a second voltage map over a period of from 0.2 milliseconds to 10 milliseconds.

10. The method of operating a charge detection mass spectrometer (CDMS) according to claim 1, wherein the first ion oscillation frequency is determined by performing a fast Fourier transform on the first CDMS data; and/or
the second ion oscillation frequency is determined by performing a fast Fourier transform on the second CDMS data.

11. A method of operating a charge detection mass spectrometer (CDMS), the CDMS comprising:
an electrostatic ion trap comprising a plurality of electrodes,
a detection tube, and
an amplification device connected to the detection tube having a plurality of
selectable resonant amplification frequency range or ranges,
wherein the method comprises:
a) introducing a first ion into the electrostatic ion trap at a first ion energy,
b) setting the voltage of the plurality of electrodes to a first voltage map,
c) obtaining first CDMS data indicative of a first ion oscillation frequency,
d) selecting the resonant amplification frequency range or ranges to correspond with the first ion oscillation frequency, and
e) obtaining second CDMS data indicative of the first ion oscillation frequency.

12. The method of operating a charge detection mass spectrometer (CDMS) according to claim 11, wherein the amplification device comprises:
an amplifier with a plurality of selectable resonant amplification frequency range or ranges, and/or
an array of a plurality of selectable amplifiers, each selectable amplifier having a resonant amplification frequency range or ranges.

13. The method of operating a charge detection mass spectrometer (CDMS) according to claim 11, wherein the method comprises performing the following steps in the following order:
c) obtaining first CDMS data indicative of a first ion oscillation frequency,
d) selecting the resonant amplification frequency range or ranges to correspond with the first ion oscillation frequency, and
e) obtaining second CDMS data indicative of the first ion oscillation frequency.

14. The method of operating a charge detection mass spectrometer (CDMS) according to claim 13, wherein the method further comprises:
g) changing the first ion energy to a second ion energy and/or changing the first voltage map to a second voltage map,
h) obtaining third CDMS data indicative of a second ion oscillation frequency,
i) selecting the resonant amplification frequency range or ranges to correspond with the second first ion oscillation frequency,
j) obtaining fourth CDMS data indicative of the second ion oscillation frequency.

15. A charge detection mass spectrometer (CDMS) for carrying out the method of claim 11, the CDMS comprising:
an electrostatic ion trap comprising a plurality of electrodes configurable to be set to a first voltage map;
a detection tube; and
an amplification device connected to the detection tube,
the amplification device having a plurality of selectable resonant amplification frequency range or ranges.

16. A charge detection mass spectrometer (CDMS) according to claim 15, wherein the amplification device comprises:
an amplifier with a plurality of selectable resonant amplification frequency ranges, and/or
an array of a plurality of selectable amplifiers, wherein at least one of the plurality of selectable amplifiers is a resonant amplifier having a resonant amplification frequency range or ranges; and/or wherein at least one of the plurality of selectable amplifiers is a non-resonant amplifier.

17. A charge detection mass spectrometer (CDMS) according to claim 15, wherein the CDMS comprises a plurality of detection tubes.

18. A charge detection mass spectrometer (CDMS) according to claim 17, wherein the amplification device comprises an array of a plurality of selectable amplifiers, wherein at least one of the plurality of selectable amplifiers is a resonant amplifier having a resonant amplification frequency range or ranges; and/or wherein at least one of the plurality of selectable amplifiers is a non-resonant amplifier, the plurality of selectable amplifiers being connected to each of the plurality of detection tubes.

19. A charge detection mass spectrometer (CDMS) according to claim 17, wherein the CDMS further comprises at least one refocusing optic between each of the plurality of detection tubes.
